(19) United States
(12) Patent Application Publication
(10) Pub. No.: US 2007/0281078 A1
(43) Pub. Date: Dec. 6, 2007

(54) Patterned media, method of manufacturing the same, and magnetic recording/reproducing apparatus

(75) Inventors: Akira Kikitsu, Yokohama-shi (JP); Yoshiyuki Kamata, Tokyo (JP); Masatoshi Sakurai, Tokyo (JP); Satoshi Shirotori, Fuchu-shi (JP)

Correspondence Address: PILLSBURY WINTHROP SHAW PITTMAN, LLP;Eric S. Cherry - Docketing Supervisor, P.O. BOX 10500, MCLEAN, VA, 22102, US

(73) Assignee: KABUSHIKI KAISHA TOSHIBA, Tokyo (JP)

(21) Appl. No.: 11/806,229

(22) Filed: May 30, 2007

(30) Foreign Application Priority Data
May 31, 2006 (JP) 2006-152120

(51) Int. Cl. G11B 5/65; B05D 5/12

(52) U.S. Cl. 427/127; 428/836; 428/836.2; 428/836.3

(57) ABSTRACT

According to one embodiment, a patterned media includes a magnetic film processed into patterns for tracks, servo zones or data zones, and a nonmagnetic filling material filled between patterns of the magnetic film for the tracks, servo zones or data zones and including a base material and a barrier material formed of a metal that does not constitute the base material.

### CROSS-REFERENCE TO RELATED APPLICATIONS

This application is based upon and claims the benefit of priority from the Japanese Patent Application No. 2006-152120, filed May 31, 2006, the entire contents of which are incorporated herein by reference.

### BACKGROUND

1. Field

One embodiment of the present invention relates to a patterned media, a method of manufacturing the patterned media and a magnetic recording/reproducing apparatus using the patterned media.

2. Description of the Related Art

In recent years, a patterned media has been actively researched as a technique of realizing a high-density magnetic recording/reproducing apparatus (HDD). In a conventional HDD media, recording and reproducing of information are performed by means of a read-write head at an arbitrary position on a continuous magnetic film. By contrast, the patterned media has patterned magnetic films processed into prescribed patterns in advance in which recording and reproducing of information are performed by means of a read-write head in accordance with the patterns. With respect to configuration of processed patterns, there are studied a so-called discrete track media (DTM, DTR) in which only servo data and recording tracks are processed where recording is performed in the circumferential direction in accordance with a conventional method; and a so-called discrete bit media (or bit patterned media, BPM) in which patterns of bit units are processed in the circumferential direction as well as servo data.

Such a discrete track media or discrete bit media has advantages as described below. First, forming the servo data on the media in advance makes it possible to reduce a manufacturing time conventionally required for magnetically recording servo data and also to reduce equipment cost. In addition, magnetic films are not provided between tracks or between magnetization reversal units and no noise is generated therefrom, which makes it possible to improve signal quality (SNR). This enables to manufacture high-density magnetic recording media and magnetic recording apparatuses.

On the other hand, in the discrete track media or the discrete bit media, since it is necessary to process a magnetic film into fine patterns, there is a risk of damaging the magnetic film during processing.

For example, there is a possibility that magnetic characteristics of the magnetic film are degraded due to oxidization of a magnetic element such as Co, which may lead to adverse influence on recording/reproducing of information. Although processing is carried out while maintaining high vacuum, there is a possibility that degradation occurs due to moisture or oxygen as impurities contained in the process gas or process equipment. In addition, there is a possibility that, depending on an environment in which a magnetic recording apparatus is to be installed, an element contained in an underlayer may be eluted to form protrusions on the surface of the media. In such a case, the read-write head flying over the media in an order of 10 nm may collide with the protrusions, leading to a crash. Perpendicular magnetic recording media under development in recent years have a complicated film structure in which a soft underlayer (SUL) is employed and a variety of elements are deposited comparatively thick in comparison with conventional media. Therefore, it is further necessary to take the element elution into consideration. In the discrete track media or the discrete bit media, there are portions having no recording layer. Even if such portions are filled with a nonmagnetic film, there is a possibility that the manner of element elution from the underlayer is different than a case where the media is covered with a recording layer on the entire surface.

Conventionally, there has been known a patterned media using, as a filling material to be filled between patterns of the magnetic film, three layers of a stop layer, a lower nonmagnetic film and an upper nonmagnetic film (see Jpn. Pat. Appln. KOKAI Publication No. 2005-135455). However, the stop layer is intended to prevent the magnetic film from being etched at the time of flattening etching. In fact, the prior art does not consider preventing elution of an element from the underlayer as described above. In addition, since the etching rate of the stop layer is lower than that of the nonmagnetic film, the stop layer remains also on the magnetic film.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a perspective view schematically showing a patterned media;

FIG. 2 is an enlarged plan view showing a data zone and a servo zone of a discrete track media;

FIG. 3 is an enlarged plan view showing a data zone and a servo zone of a discrete bit media;

FIG. 4 is a cross-sectional view of a patterned media according to a first embodiment of the present invention;

FIG. 5 is a cross-sectional view of a patterned media according to a second embodiment of the present invention;

FIG. 6 is a cross-sectional view of a patterned media according to a third embodiment of the present invention;

FIGS. 7A, 7B, 7C, 7D, 7E and 7F are cross-sectional views showing a method of manufacturing the patterned media according to the first embodiment of the present invention;

FIGS. 8A, 8B, 8C and 8D are cross-sectional views showing another method of manufacturing the patterned media according to the first embodiment of the present invention;

FIGS. 9A and 9B are cross-sectional views showing patterned media manufactured by manufacturing methods according to other embodiments of the present invention; and

FIG. 10 is a perspective view of a magnetic disk apparatus according to an embodiment of the present invention.

### DETAILED DESCRIPTION

Various embodiments according to the invention will be described hereinafter with reference to the accompanying drawings. In general, according to one embodiment of the present invention, there is provided a patterned media comprising: a magnetic film processed into patterns for tracks, servo zones or data zones; and a nonmagnetic filling material filled between patterns of the magnetic film for the tracks, servo zones or data zones and including a base material and a barrier material formed of a metal that does not constitute the base material. According to another embodiment of the present invention, there is provided a method of manufacturing a patterned media, comprising: processing a magnetic film into patterns for tracks, servo zones or data zones; depositing a barrier material and a base material to form a nonmagnetic filling material between and on the patterns of the magnetic film for the tracks, servo zones or data zones; and etching the base material and the barrier material on the patterns of the magnetic film, the barrier material being higher in an etching rate than the base material. According to still another aspect of the present invention, there is provided a magnetic recording/reproducing apparatus, comprising: the above patterned media; and a read-write head incorporated in a slider having a designed flying height of 15 nm or less.

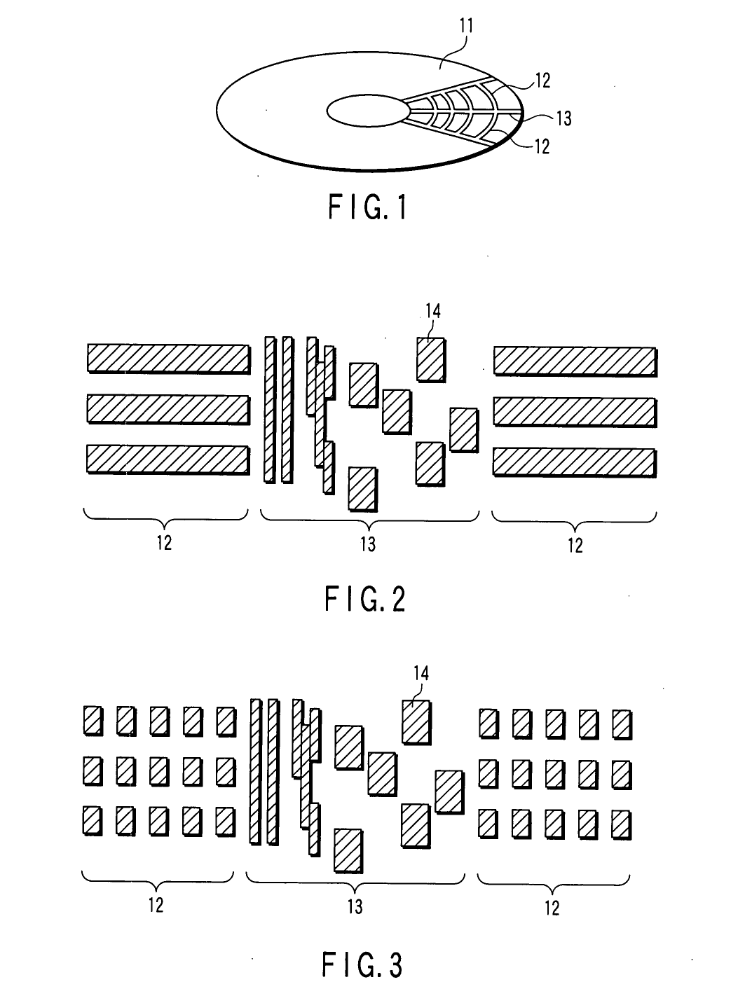

FIG. 1 is a perspective view schematically showing a patterned media. Sectors are formed on a surface of a patterned media 11. In the sectors, there exist a data zone 12 to which user data are written and a servo zone 13 for tracking and data access control including burst signals, an address, a preamble and the like. FIG. 1 schematically shows arrangement of these zones on the disk surface by way of lines.

FIG. 2 is an enlarged plan view showing a data zone and a servo zone of a discrete track media. In the data zone 12 in FIG. 2, patterns of a magnetic film are separated by a nonmagnetic filling material so as to form continuous tracks in the circumferential direction. In the servo zone 13 in FIG. 2, patterns of the magnetic film are formed corresponding to servo patterns of an existing magnetic recording media. The servo zone 13 includes burst signals 14 for carrying out tracking control, for example.

FIG. 3 is an enlarged plan view showing a data zone and a servo zone of a discrete bit media. In the data zone 12 in FIG. 3, patterns of a magnetic film are separated by a nonmagnetic filling material so as to form data bits.

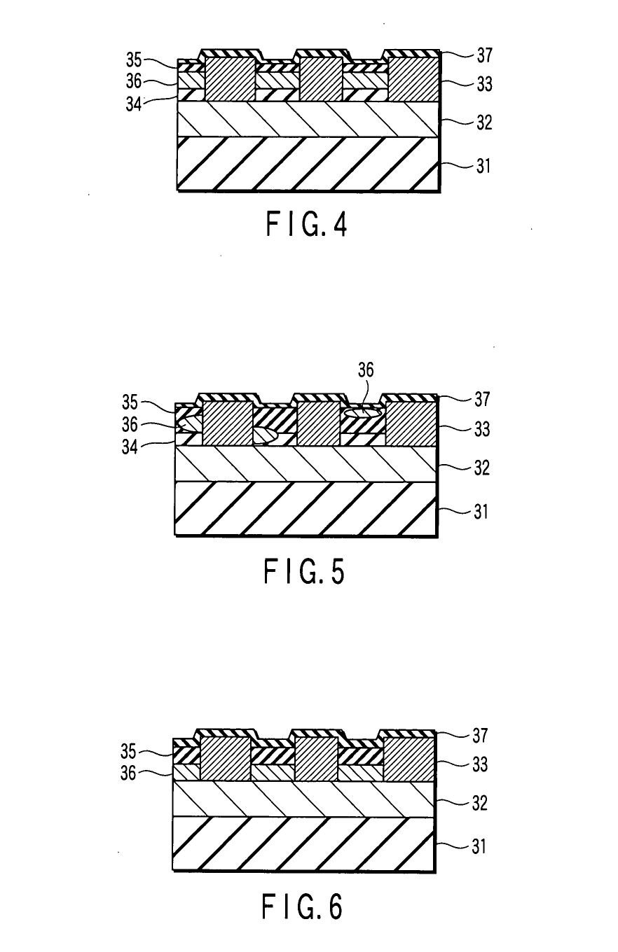

FIG. 4 is a cross-sectional view showing a patterned media according to a first embodiment of the present invention. An underlayer 32 and a magnetic recording layer 33 made of a patterned magnetic film are formed on a substrate 31. A nonmagnetic filling material prepared by stacking a first filling material 34, a barrier material 36 and a second embedding layer 35 is filled in recesses between patterns of the magnetic recording layer 33. A protective layer 37 is formed on the structure.

The substrate 31 may be, for example, a glass substrate, an Al alloy substrate, a ceramic substrate, a carbon substrate, a Si single-crystal substrate having an oxide on the surface thereof, and those having a plated NiP layer on the surface of the substrates described above. The glass substrate includes amorphous glass or crystallized glass. The amorphous glass includes generally used soda lime glass and aluminosilicate glass. The crystallized glass includes lithium-based crystallized glass. The ceramic substrate includes a sintered body mainly formed of generally used aluminum oxide, aluminum nitride or silicon nitride, or a material obtained by fiber-reinforcing the sintered body.

The underlayer 32 includes a material that is generally employed for HDD media. In general, a nonmagnetic thin film is employed for the purpose of controlling crystalline orientation or a fine structure of a recording layer. In the case where a CoCrPt alloy is employed for a recording layer of a perpendicular magnetic recording media, Pt, Pd, Ru, Ti, W, Ta, or a material obtained by adding SiO₂ to these elements is employed for the underlayer. In view of manufacturing and cost efficiency, the underlayer should preferable be as thin as possible. Typically, the thickness of the underlayer is in the range of 1 nm to 50 nm. In particular, in the case of the perpendicular magnetic recording media, a so-called soft magnetic underlayer will be employed.

The soft underlayer is provided so as to pass a recording field from a magnetic head such as a single-pole head to magnetize the perpendicular recording layer therein and to return the recording field to a return yoke arranged near the recording magnetic pole. That is, the soft underlayer provides a part of the function of the write head, serving to apply a steep perpendicular magnetic field to the recording layer so as to improve recording and reproduction efficiency. The soft underlayer may be made of a material containing at least one of Fe, Ni, and Co. Such materials include an FeCo alloy such as FeCo and FeCoV, an FeNi alloy such as FeNi, FeNiMo, FeNiCr and FeNiSi, an FeAl alloy and FeSi alloy such as FeAl, FeAlSi, FeAlSiCr, FeAlSiTiRu and FeAlO, an FeTa alloy such as FeTa, FeTaC and FeTaN, and an FeZr alloy such as FeZrN. The soft underlayer may be made of a material having a microcrystalline structure or a granular structure containing fine grains dispersed in a matrix such as FeAlO, FeMgO, FeTaN and FeZrN, each containing 60 at % or more of Fe. The soft underlayer may be made of other materials such as a Co alloy containing Co and at least one of Zr, Hf, Nb, Ta, Ti and Y. The material preferably contains 80 at % or more of Co. An amorphous layer can be easily formed when the Co alloy is deposited by sputtering. The amorphous soft magnetic material exhibits very excellent soft magnetism because of free from magnetocrystalline anisotropy, crystal defects and grain boundaries. The use of the amorphous soft magnetic material may reduce media noise. Preferred amorphous soft magnetic materials include, for example, a CoZr-, CoZrNb- and CoZrTa-based alloys.

Another underlayer may be provided under the soft underlayer in order to improve the soft underlayer in the crystallinity or in the adhesion to the substrate. Materials for the underlayer include Ti, Ta, W, Cr, Pt, and an alloy thereof, and oxide and nitride containing the above metal.

An intermediate layer may be provided between the soft underlayer and the recording layer. The intermediate layer serves to cut off exchange coupling interaction between the soft underlayer and the recording layer and to control the crystallinity of the recording layer. Materials for the intermediate layer include Ru, Pt, Pd, W, Ti, Ta, Cr, Si and an alloy thereof, and oxide and nitride containing the above metal.

To prevent spike noise, the soft underlayer may be divided into layers antiferromagnetically coupled with each other through a Ru layer with a thickness of 0.5 to 1.5 nm sandwiched therebetween. Alternatively, the soft underlayer may be exchange-coupled with a pinning layer made of a hard magnetic layer with in-plane anisotropy such as CoCrPt, SmCo and FePt or an antiferromagnetic layer such as IrMn and PtMn. In this case, to control the exchange coupling force, a magnetic layer such as Co or a nonmagnetic layer such as Pt may be provided on and under the Ru layer.

It is preferable that the thickness of the soft underlayer be in a range of 1 nm to 200 nm. In the case where the thickness is smaller than 1 nm, a continuous thin film is not produced, and a sufficient function to return the recording magnetic field cannot be achieved. If the thickness exceeds 200 nm, stripping easily occurs because of internal stress and a media cost disadvantageously increases. It is more preferable that the thickness of the soft underlayer be in a range of 10 nm to 80 nm.

As the magnetic recording layer 33, there can be used a general longitudinal magnetic recording layer or a perpendicular magnetic recording layer. Since a patterned media has been developed as a high-density HDD media, a perpendicular magnetic recording layer is often employed.

The perpendicular recording layer 33 is preferably made of a material mainly containing Co, containing at least Pt, and further containing an oxide. The perpendicular magnetic recording layer may include Cr as desired. Particularly suitable oxide is silicon oxide and titanium oxide. The perpendicular recording layer preferably has a structure in which magnetic grains, i.e., crystalline grains with magnetism are dispersed in the layer. The magnetic grains preferably have a columnar configuration penetrating the perpendicular recording layer. Such a structure improves orientation and crystallinity of the magnetic grains in the perpendicular recording layer, making it possible to provide a signal-to-noise ratio (SNR) suitable for high-density recording. The amount of oxide is important for obtaining the above structure.

An amount of oxide to be contained is important to obtain such a structure. The oxide content to the total amount of Co, Pt and Cr is preferably 3 mol % or more and 12 mol % or less, more preferably 5 mol % or more and 10 mol % or less. If the oxide content of the perpendicular recording layer is within the above range, the oxide is precipitated around the magnetic grains, making it possible to isolate the magnetic grains and to reduce their sizes. If the oxide content exceeds the above range, the oxide remains in the magnetic grains to degrade the orientation and crystallinity. Moreover, the oxide is precipitated over and under the magnetic grains to prevent formation of the columnar structure penetrating the perpendicular recording layer. On the other hand, if the oxide content is less than the above range, the isolation of the magnetic grains and the reduction in their sizes are insufficient. This increases media noise in reproduction and makes it impossible to obtain a SNR suitable for high-density recording.

The Cr content of the perpendicular recording layer is preferably 0 at % or more and 16 at % or less, more preferably 10 at % or more and 14 at % or less. When the Cr content is within the above range, high magnetization can be maintained without unduly reduction in the uniaxial magnetic anisotropy constant Ku of the magnetic grains. This brings read/write characteristics suitable for high-density recording and sufficient thermal fluctuation characteristics. If the Cr content exceeds the above range, Ku of the magnetic grains decreases to degrade the thermal fluctuation characteristics as well as to degrade the crystallinity and orientation of the magnetic grains. As a result, the read/write characteristics may be degraded.

The Pt content of the perpendicular recording layer is preferably 10 at % or more and 25 at % or less. When the Pt content is within the above range, the perpendicular recording layer provides a required uniaxial magnetic anisotropy constant Ku. Moreover, the magnetic grains exhibit good cyrstallinity and orientation, resulting in thermal fluctuation characteristics and read/write characteristics suitable for high-density recording. If the Pt content exceeds the above range, a layer of an fcc structure may be formed in the magnetic grains to degrade the crystallinity and orientation. On the other hand, if the Pt content is less than the above range, it is impossible to obtain Ku to provide thermal fluctuation characteristics suitable for high-density recording.

The perpendicular recording layer may contain not only Co, Pt, Cr and an oxide but also one or more additive elements selected from the group consisting of B, Ta, Mo, Cu, Nd, W, Nb, Sm, Tb, Ru and Re. These additive elements enable to facilitate reduction in the sizes of the magnetic grains or to improve the crystallinity and orientation. This in turn makes it possible to provide read/write characteristics and thermal fluctuation characteristics more suitable for high-density recording. These additive elements may preferably be contained totally in 8 at % or less. If the total content exceeds 8 at %, a phase other than the hcp phase is formed in the magnetic grains. This degrades crystallinity and orientation of the magnetic grains, making it impossible to provide read/write characteristics and thermal fluctuation characteristics suitable for high-density recording.

Other materials for the perpendicular recording layer include a CoPt alloy, a CoCr alloy, a CoPtCr alloy, CoPtO, CoPtCrO, CoPtSi and CoPtCrSi. The perpendicular recording layer may be formed of a multilayer film containing a Co film and a film of an alloy mainly including an element selected from the group consisting of Pt, Pd, Rh and Ru. The perpendicular recording layer may be formed of a multilayer film such as CoCr/PtCr, CoB/PdB and CoO/RhO, which are prepared by adding Cr, B or O to each layer of the above multilayer film.

The thickness of the perpendicular recording layer preferably ranges between 1 nm and 60 nm, more preferably between 5 nm and 40 nm. The perpendicular recording layer having a thickness within the above range is suitable for high-density recording. If the thickness of the perpendicular recording layer is less than 1 nm, read output tends to be so low that a noise component becomes relatively high. On the other hand, if the thickness of the perpendicular recording layer exceeds 60 nm, read output tends to be so high as to distort waveforms. The coercivity of the perpendicular recording layer is preferably 237,000 A/m (3 kOe) or more. If the coercivity is less than 237,000 A/m (3 kOe), the thermal fluctuation tolerance may be degraded. The perpendicular squareness of the perpendicular recording layer is preferably 0.8 or more. If the perpendicular squareness is less than 0.8, the thermal fluctuation tolerance tends to be degraded.

The protective layer 37 serves to prevent corrosion of the perpendicular recording layer and to prevent damage to the media surface when the magnetic head comes into contact with the media. Materials for the protective layer include, for example, C, SiO₂ and ZrO₂. The protective layer preferably has a thickness of 1 to 10 nm. When the thickness of the protective layer is within the above range, the distance between the head and the media can be reduced, which is suitable for high-density recording. Carbon can be classified into sp²-bonded carbon (graphite) and sp³-bonded carbon (diamond). The sp³-bonded carbon is more excellent in durability and anticorrosion but is inferior in surface smoothness to graphite. Normally, carbon is deposited by sputtering using a graphite target. This method forms amorphous carbon in which the sp²-bonded carbon (graphite) and sp³-bonded carbon are mixed. The amorphous carbon containing the sp₃-bonded carbon in a high ratio is referred to as diamond-like carbon (DLC). The DLC exhibits excellent durability and anticorrosion and also is excellent in the surface smoothness because it is amorphous. In chemical vapor deposition (CVD), DLC is produced through excitation and decomposition of raw material gases in plasma and reaction of the decomposed species, so that DLC further rich in the sp³-bonded carbon can be produced.

A lubricating layer can be provided on the protective layer. As a lubricating agent used in the lubricating layer includes well-known materials such as perfluoropolyether, fluorinated alcohol and fluorinated carboxylic acid.

Referring now to FIG. 4, a more detailed description will be given with respect to a patterned media according to a first embodiment of the present invention.

A magnetic recording layer 33, as shown in FIGS. 1 and 2, is processed and isolated into patterns of servo signals, tracks, or magnetization reversal units. Recesses between patterns of the magnetic layer 33 from which the magnetic recording layer 33 has been removed should be nonmagnetic. Because air is also nonmagnetic, the recesses may be left as they are after the magnetic film is removed. However, it is preferable to fill a nonmagnetic film in the recesses in consideration of head flying stability. In the present specification, a material to be filled in these portions is referred to as a (nonmagnetic) filling material. In the case where the filling material is present on the magnetic recording layer 33, it is preferable that the thickness thereof should be as small as possible in order to reduce a spacing loss. In general, the nonmagnetic filling material includes SiO₂, C, TiO, TiN and the like.

In the present invention, the nonmagnetic filling material is constituted by a base material 34, and a barrier material 36. The base material is made of a material identical to that of a conventional nonmagnetic filling material. Specifically, the base material is composed of C or a compound of Si, Ta or Ta with O or N. The barrier material is formed of a metal unlike the base material. Specifically, the barrier material contains at least one metal selected from the group consisting of Mg, Al, Ti, V, Cu, Zn, Ga, Ce, Sr, Zr, Nb, Mo, In, Sn, Sb, Te, Be, Hf, Ta and W. In the case where the base material is made of an oxide or a material including oxygen as an impurity (such as SiN, TiN, or TaN), there is a possibility that oxygen is released during a deposition process, which may oxidize and degrade the magnetic film. In the case where the base material is made of C that is free of oxygen, there is a possibility that a magnetic film is oxidized and degraded by an impurity gas (such as O or H₂O) contained in the process gas (for example, Ar gas used for sputtering). On the other hand, in the case of the magnetic recording media according to the present invention, since a barrier material made of a metal is included in the filling material, the barrier material is preferentially oxidized, i.e., an oxygen gettering function is exerted, thereby making it possible to prevent oxidization of the magnetic film. In particular, Mg, Al, Ti, Sr, Zr, In, Sn, Te, Ba, Hf, Ta, or W is preferable because they are high in oxygen affinity. In addition, since the oxide of the barrier material thus formed contains a stable chemical bond, the oxide layer functions as a barrier layer that prevents an element present on the substrate side from diffusing to the surface side.

The barrier material may exist in a nonmagnetic filling material. In the case where it is assumed that a large amount of oxygen is not included in a process, only a small amount of barrier material will suffice. FIG. 4 shows a case where the barrier material 36 exists in a form of a layer between the first base material 34 and the second base material 35. In other words, the layer of the first base material 34 is provided on the underlayer 32, the layer of the barrier material 36 is provided on the layer of the first base material 34, and the layer of the second base material 35 is provided on the layer of the barrier material 36. The first base material 34 and the second base material 35 may be same or different. In the case of the same material, there is an advantage that a manufacturing process is simplified. On the other hand, in the case of different materials (including a case in which they are different in composition or fine structure), their functions can be different from each other. For example, it is possible to impart a function of improving adhesion and relaxing internal stress to the first base material 34 and to impart a function of improving adhesion with the protective layer 37 to the second base material 35.

The barrier material 36 may not always be layered as long as it can trap oxygen during processes. Referring now to FIG. 5, a description will be given with respect to a patterned media according to a second embodiment of the present invention. In the figure, grains of a barrier material 36 are dispersed in the first base material 34 and the second base material 35.

Two base materials may not always be employed. Referring now to FIG. 6, a description will be given with respect to a patterned media according to a third embodiment of the present invention. In the figure, a layer of a barrier material 36 is provided on the underlayer 32, and a layer of a base material 35 is provided on the layer of the barrier material 36. In this case as well, the barrier material 36 may be grains in the same manner as that in FIG. 5. In addition, grains of barrier material 36 may be dispersed in the center portion of one type of base material 34. This corresponds to a case where the first base material 34 and the second base material 35 are made of the same material in FIG. 5.

In any of FIGS. 4 to 6, the barrier material 36 may be provided on the magnetic recording layer 33. However, it is preferable that the barrier material 36 on the magnetic recording layer 33 be as thin as possible in order to reduce the spacing loss.

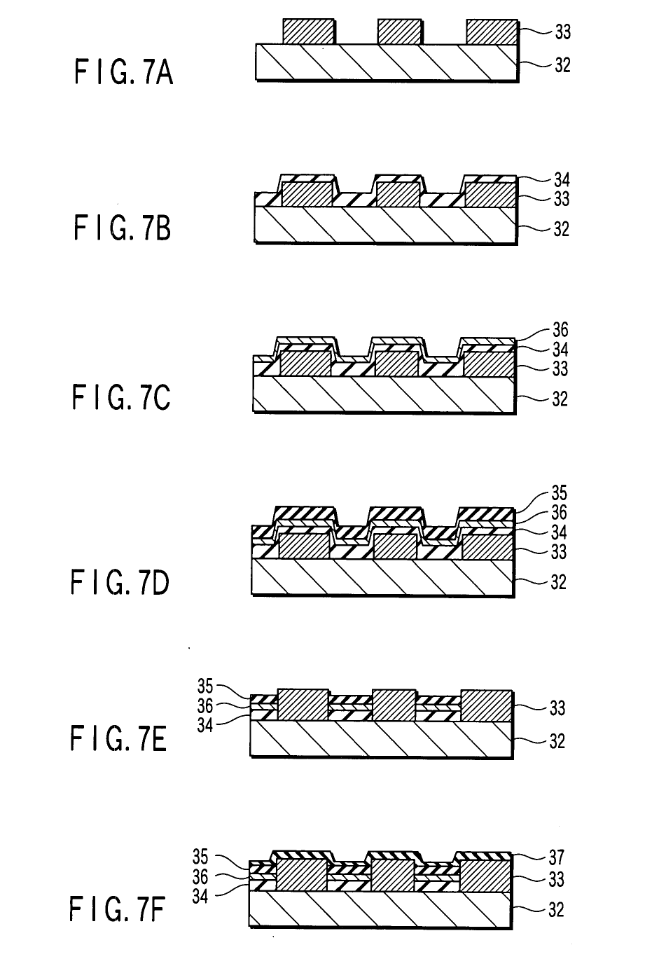

Referring now to FIGS. 7A, 7B, 7C, 7D, 7E and 7F, a description will be given with respect to a method of manufacturing the patterned media according to the first embodiment of the present invention. In these figures, a substrate 31 is not shown for the sake of simplicity.

First, a magnetic film is deposited on an underlayer 32. A patterned magnetic recording layer 32 is formed by processing the magnetic film in accordance with known processes. At this time, as a method of patterning the magnetic film, there can be employed a technique such as an imprint lithography or an electron beam lithography (FIG. 7A). Next, a first base material 34 is deposited by sputtering or the like (FIG. 7B). Then, a barrier material 36 is deposited by sputtering or the like (FIG. 7C). Further, a second base material 35 is deposited by sputtering or the like (FIG. 7D).

Next, a flattening process by etching is carried out. At this time, in the case where the base material is made of SiO₂, flattening is carried out by RIE using CF₄. In the case where the base material is made of C, flattening is carried out by RIE using O. Sputter-etching may be carried out with the use of Ar or the like without using a reactive gas, or reactive sputter-etching may be carried out with the use of Ar or the like by adding the reactive gas described above. The etching may be carried out at the same time as deposition of the first base material 34 and/or the second base material 34. For example, bias sputtering may be carried out, or alternatively, bias sputtering may be carried out while mixing a reactive gas used for RIE. By these etching processes, almost no base material exists on the magnetic recording layer 33, and on the other hand, the filling material is provided between patterns of the magnetic recording layer 33 (FIG. 7E). As a result, surface irregularity becomes smaller than those after patterns of the magnetic recording layer 33 shown in FIG. 7A have been formed. The state of head flying is stabilized on the media with small surface irregularity. Thereafter, a protective layer 37 is deposited (FIG. 7F).

Even if oxygen exists as an impurity in the processes described above, the barrier material 36 traps oxygen so that oxidization of the magnetic recording layer 33 can be suppressed. Depending on conditions for the etch-back process, the barrier material 36 can be left in a form of a layer, or alternatively, the barrier material 36 can be formed in a form of grains which are dispersed in the base material. In any case, the oxidization of the magnetic recording layer 33 can be suppressed. The barrier material 36 can also prevent an element of the underlayer 33 from diffusing toward the surface. The morphology of the barrier material 36 can be properly selected according to applied process conditions, the material of the underlayer material, the material of the magnetic recording layer, and media cost. For example, the patterned media in which the first base material is not provided on the underlayer 32 shown in FIG. 6 can be fabricated by eliminating the process of depositing the first base material in the processes described above.

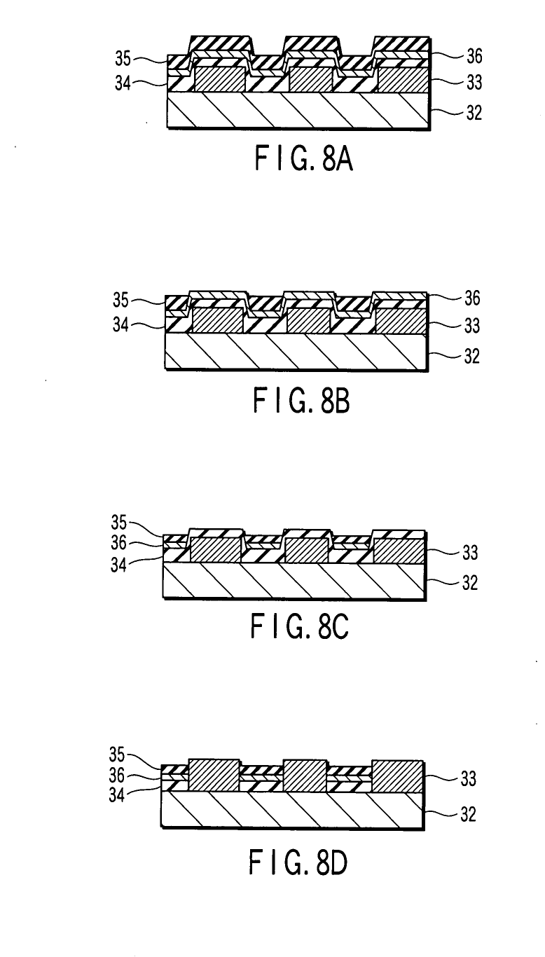

The inventors also found that a more stable patterned media can be manufactured by utilizing oxygen trap with a barrier material. A method of manufacturing the patterned media will be described with reference to FIGS. 8A, 8B, 8C and 8D. FIG. 8A corresponds to FIG. 7D. At this time, as the barrier material 36, there is used a material of which etching rate in later etch-back is higher than those of the base materials 34 and 35.

First, the second base material 35 is etched. As a result, the barrier material 36 is exposed onto the magnetic recording layer 33 (FIG. 8B). The etching end point of the second base material 35 can be detected by monitoring constituent elements of the barrier material 36 by plasma spectroscopy or mass filter. Based on preliminary testing, the etching of the second base material 35 may be time-controlled. In this etching, a gas slightly containing oxygen or an impurity can be used. For example, SiO₂ or C may be etched at a high speed under high pressure Ar. Also, SiO₂ can be etched in a CF₄-containing atmosphere or C can be etched in an oxygen-containing atmosphere. At this time, the barrier material 36 can trap the impurity gas, making it possible to prevent the impurity from mixing with the base material in a gaseous state.

Next, etching is carried out under a condition in which an amount of an impurity such as oxygen is small. For example, etching is carried out at a comparatively low speed with the use of high-purity Ar. At this time, since the etching rate of the barrier material 36 is higher than those of the base materials 34 and 35, the barrier material 36 on the magnetic recording layer 33 first removed. As a result, the surface irregularity can be further reduced (FIG. 8C). Then, etching is carried out under less damaging conditions, and the etching is stopped at a point where the magnetic recording layer 33 is completely exposed or at a point where the base material slightly remains on the magnetic recording layer 33 (FIG. 8D). Thereafter, a protective layer 37 is deposited as shown in FIG. 7F.

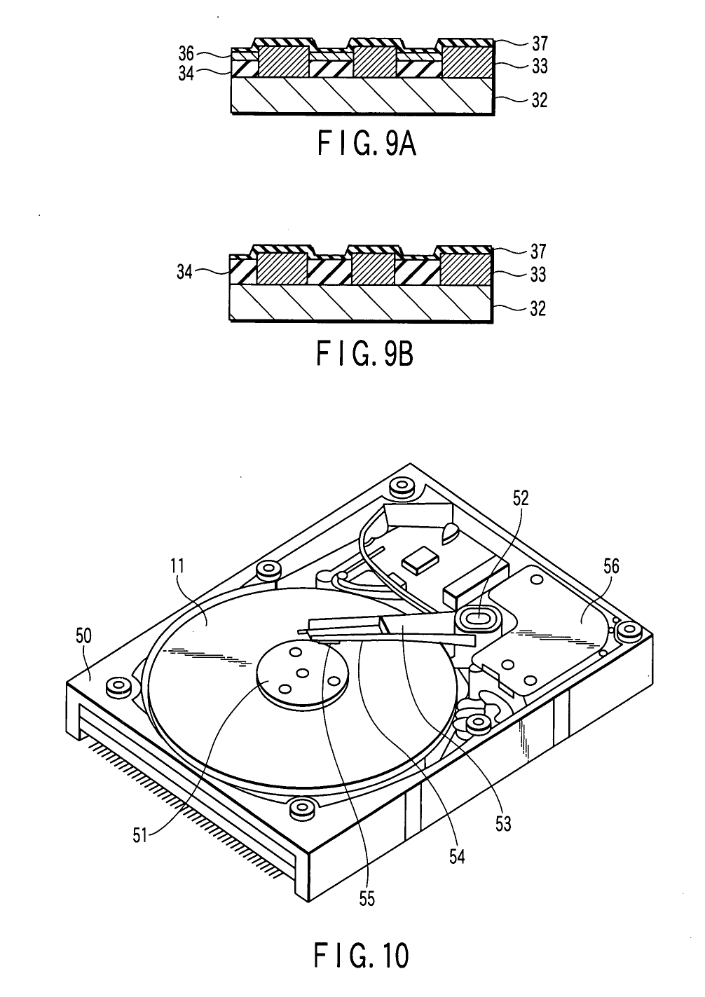

In the manufacturing method described above, the second base material 34 may be removed as shown in FIG. 9A. Alternatively, the barrier material 36 may be removed as shown in FIG. 9B. In the case of FIG. 9B, although the function of preventing oxidization at the time of deposition process of the protective layer or the function of suppressing diffusion of an element from the underlayer cannot be expected, media cost can be reduced because there is no need of depositing thick the barrier material or the second base material.

A primary object of the method of manufacturing the patterned media described with reference to FIGS. 8A, 8B, 8C and 8D is to use, as a barrier material, a metal of which etching rate is higher than that of a base material, deposit a base material on the barrier material, and then, carry out etching. A process of depositing the first base material may or may not be carried out.

Jpn. Pat. Appln. KOKAI Publication No. 2005-135455 discloses a method similar to the method of manufacturing the patterned media according to the present invention described in FIGS. 8A, 8B, 8C and 8D. In this document, a stack of a stop layer, a lower nonmagnetic film and an upper nonmagnetic film is used as the nonmagnetic filling material. However, the etching rate of the stop layer is lower than those of the nonmagnetic films. In this respect, the disclosed method has a reversed relationship from that of the present invention. As disclosed in this document, a stop layer of which etching rate is low is widely used for the purpose of flattening by etching, and thus this technique would be readily achieved. In contrast, the present invention uses a barrier material and base material in a reversed relationship with the above technique, and would not have been readily achieved based on the conventional technique. Further, in the manufacturing method described in the above document, since the etching rate of the stop layer is low, the stop layer inevitably remains on the magnetic film. Therefore, structures as shown in FIGS. 4, 5 and 6 of the present invention cannot be obtained. Although the above document describes that the stop layer on the magnetic film can be eliminated, it fails to disclose specifically how it can be preformed. Accordingly, such a method seems to be substantially impossible.

### EXAMPLES

### Example 1

In this Example, a patterned media shown in FIG. 4 was fabricated. The following films were deposited on a glass disk substrate of 1.8 inches. A film construction is as follows: a glass substrate/a soft underlayer made of 80 nm-thick CoZrNb/an intermediate layer made of 5 nm-thick Ti/an intermediate layer made of 10 nm-thick Ru/a magnetic recording layer made of 15 nm-thick CoCrPt—SiO₂. On the structure, 5 nm-thick carbon as a protective layer was deposited by sputtering.

On the protective layer, a resist was applied by spin coating. SOG (spin-on-glass), which changes to SiO₂ through sintering at high temperatures, was used as the resist. A patterned media was fabricated by imprint lithography as described below. A Ni stamper was prepared in advance. The Ni stamper has both of: patterns corresponding to a discrete track media in which servo signals and recording tracks have been formed by protrusions; and patterns corresponding to a discrete bit media (bit pattern media) in which servo signals and bit patterns have been formed by protrusions. The stamper was fabricated using a technique similar to that for a DVD stamper. The stamper was brought into pressure contact with the resist under 2,000 bar for 60 seconds to transfer the patterns to the resist (imprinting). In order to retain protrusions of the imprinted SOG, high temperature sintering was carried out at 450° C. An oxygen exposure process is also effective to retain the protrusions of SOG. It should be noted that the resist is not limited to SOG, but there can be used: an aluminum alkoxide or aluminum oxide particle dispersed resist which is converted into alumina by oxygen exposure or high-temperature sintering; a titanium oxide particle dispersed resist which is converted into titania by oxygen exposure or high-temperature sintering.

Thereafter, a first base material 34, a barrier material 36, and a second base material 35 were sequentially stacked, and then, flattening was carried out by etching. After the flattening process, a protective layer 37 made of C was deposited by CVD, and then a lubricating agent was applied. Table 1 shows materials for the first base material, the barrier material, and the second base material.

With respect to the fabricated media, the microscopic structure of the base materials was observed with a cross-sectional TEM (transmission electron microscope). When elements were identified by EDX, it was found that the barrier material was present in the base materials. The barrier material was formed in grains or in a layer depending on difference in the base material or the stacked structure. Table 1 shows whether the barrier material is formed in grains or a layer. “Comparative Example” denotes a media fabricated using only a single base material. “Control” denotes a general HDD media not a patterned media.

The magnetic characteristics of a media were evaluated by Kerr effect measurement. The nucleation field Hn was taken as an evaluation item, because this value well reflects a change caused by degradation of the magnetic characteristics due to oxidization. The Hn value wad determined by measuring Hn values at eight points on the circumference having a radium of 16 mm and averaging these values. Table 1 shows the Hn values.

In addition, a flying test was carried out using a drive having a head slider of flying height of 9 nm (average value of 9 nm with deviation of ±1 nm) to which a media was installed.

FIG. 10 is a perspective view showing a magnetic recording/reproducing apparatus (HDD) according to an embodiment of the present invention. The magnetic recording apparatus comprises, in a casing 50, a magnetic recording media 11, a spindle motor 51 for rotating the magnetic recording media 11, a head slider 55 including a read-write head, a head suspension assembly for supporting the head slider 55 (suspension 54 and actuator arm 53), a voice coil motor (VCM) 56, and a circuit board. The magnetic recording media 11 is mounted to and rotated with the spindle motor 51, to which various digital data are recorded in accordance with a perpendicular magnetic recording system. A magnetic head incorporated in the head slider 55 is a so-called composite head, and includes a write head of a single-pole structure and a read head using a GMR film or TMR film. The suspension 54 is held at one end of the actuator arm 53, and the head slider 55 is supported to face the recording surface of the magnetic recording media 11 by the suspension 54. The actuator arm 53 is attached to a pivot 52. The voice coil motor (VCM) 56 as an actuator is provided on the other end of the actuator arm 53. A head suspension assembly is driven by the voice coil motor (VCM) 56, and the magnetic head is positioned at an arbitrary radial position over the magnetic recording media 11. The circuit board is equipped with a head IC and generates drive signals for the voice coil motor (VCM) and control signals for controlling read/write operations by means of the magnetic head.

A flying test was carried out as described below to evaluate presence or absence of protrusions caused by element dispersion. The media was left for one month in an environment of 60° C. and 80% RH, and then two-hour continuous operation was performed. Thereafter, AE (acoustic emission) measurement was carried out. In the AE test, if signals were observed in synchronism with rotation in ten-minute flying operation, it was judged that there were protrusions that could not be removed, and the occurrence of such protrusions was determined as “failed”. The field of AE test shows “passed” and “failed”.

As is evident from Table 1, if the barrier material exists in the base material, oxidization of the magnetic film is suppressed, leading to only a slight change in Hn. Hn is slightly lowered in comparison with 2.5 kOe for the control sample, which represents a possibility that slight oxidation was caused. However, if a decrease of Hn is to this extent, such a media does not have a problem as long as the media is not incorporated in a high-density hard disk drive. On the other hand, in Comparative Examples, Hn is decreased to negative, which corresponds to a positive external magnetic field. Therefore, it is assumed that a great change in magnetic characteristics was caused by oxidization or the like. In addition, all of the patterned media containing a barrier material in the filling material according to embodiments of the present invention were determined as “passed” in the AE test. From these results, it was found that the barrier material in the filling material has an effect of preventing formation of protrusions caused by precipitation of an element. These effects can also be attained even in the case of using different materials for the first base material and the second base material.

When a similar AE test was carried out with the HDD placed under a reduced pressure of 0.7 atm, some patterned media containing a barrier media in the filling material were determined as “failed”. In such failed patterned media, the effect of preventing precipitation of an element seems to be slightly weakened. However, the condition of 0.7 atm is so severe that is required for an in-vehicle HDD, and a patterned media that was failed in this AE test can be sufficiently applied for normal use.

TABLE 1

| | First | | Second | Morphology | | |
|---|---|---|---|---|---|---|
| | base | Barrier | base | of barrier | Hn | AE |
| | material | material | material | material | (kOe) | test |
| Example | Cu | Fe | Cu | Layer | 2 | Passed |
| Example | Cu | Tb | Cu | Grains | 1.7 | Passed |
| Example | Cu | Nd | Cu | Layer | 1.9 | Passed |
| Example | Cu | Bi | Cu | Grains | 1.7 | Passed |
| Example | SiAlON | Fe | SiAlON | Grains | 1.6 | Passed |
| Example | SiAlON | Tb | SiAlON | Grains | 1.4 | Passed |
| Example | ZrO | Nd | ZrO | Grains | 1.6 | Passed |
| Example | ZrO | Bi | ZrO | Grains | 1.4 | Passed |
| Example | Cu | Fe | CuTa | Layer | 1.9 | Passed |
| Example | Cu | Tb | CuTa | Layer | 1.7 | Passed |
| Example | Cu | Nd | CuTa | Layer | 1.8 | Passed |
| Example | Cu | Bi | CuTa | Layer | 1.5 | Passed |
| Comparative | Cu | — | — | — | −0.2 | Failed |
| Example | | | | | | |
| Comparative | SiAlON | — | — | — | −0.8 | Failed |
| Example | | | | | | |
| Comparative | ZrO | — | — | — | −0.5 | Failed |
| Example | | | | | | |
| Comparative | Cu | — | | — | −1.2 | Failed |
| Example | | | | | | |
| Control | — | — | — | — | 2.5 | Passed |

### Example 2

Patterned media and magnetic recording/reproducing apparatuses having a construction similar to that in Example 1 were fabricated. However, C, SiO₂, TaO, or TiN was used as a base material, and Fe, Tb, Nd, or Bi was used as a barrier material.

Table 2 shows materials for the first base material, barrier material, and second base material. Table 2 also shows results obtained by carrying out evaluations similar to those in Example 1. The barrier material was formed in grains or a layer depending on the material for the base materials, the stacked structure, or the material for the barrier material. It seems that the morphology of the barrier material is affected by wettability between materials or by a difference in particle energies in deposition. As in Example 1, although the patterned media containing a barrier material in the filling material according to embodiments of the present invention showed sight lowering in Hn, such lowering is within an allowable range, and they passed the AE test. In the AE test under reduced pressure, there was a tendency that a media used a base material made of oxide was likely to be “failed”, but the detailed reason for these results were unclear. As described above, even if the result is “failed” in the AE test under reduced pressure, no problem occurs because quality of the product can be ensured to some extent.

In Example 2, in comparison with Example 1, the degree of lowering of Hn is reduced. The reason is assumed that oxidization of the magnetic layer is suppressed by the use of the different base material. Since a higher Hn is advantageous in view of performance of a system, it is found preferable to use C, SiO₂, TaO, or TiN for the base material. These effects can be attained in the case where different materials are used for the first base material and the second base material.

TABLE 2

| | | | | Mor- | | | |
|---|---|---|---|---|---|---|---|
| | | Bar- | | phology | | | AE test |
| | First | rier | Second | of | | | under |
| | base | mate- | base | barrier | Hn | AE | reduce |
| | material | rial | material | material | (kOe) | test | pressure |
| Example | C | Fe | C | Layer | 2 | Passed | Passed |
| Example | C | Tb | C | Layer | 2.3 | Passed | Passed |
| Example | C | Nd | C | Layer | 2.1 | Passed | Passed |
| Example | C | Bi | C | Grains | 2 | Passed | Passed |
| Example | SiO2 | Fe | SiO2 | Grains | 2.3 | Passed | Failed |
| Example | SiO2 | Tb | SiO2 | Layer | 2.5 | Passed | Failed |
| Example | TaO | Nd | C | Layer | 2.2 | Passed | Failed |
| Example | TaO | Bi | C | Grains | 2.2 | Passed | Failed |
| Example | C | Fe | TiN | Layer | 2.1 | Passed | Passed |
| Example | C | Tb | TiN | Layer | 2 | Passed | Passed |
| Control | — | — | — | — | 2.5 | Passed | Passed |

### Example 3

Patterned media and magnetic recording/reproducing apparatuses having a construction similar to that in Example 1 were fabricated. However, Cu, CuTa, or SiAlON was used as a base material, and Mg, Al, Ti, V, Cu, Zn, Ga, Ge, Sr, Zr, Nb, Mo, In, Sn, Sb, Te, Ba, Hf, Ta, or W was used as a barrier material.

Table 3 shows materials for the first base material, barrier material, and second base material. Table 3 also shows results obtained by carrying out evaluations similar to those in Example 1. The barrier material was formed in grains or a layer depending on the material for the base materials, the stacked structure, or the material for the barrier material. As in Example 1, although the patterned media containing a barrier material in the filling material according to embodiments of the present invention showed sight lowering in Hn, such lowering is within an allowable range, and they passed the AE test. Like Example 2, in the AE test under reduced pressure, there was a tendency that a media used a base material made of oxide was likely to be “failed”, but the detailed reason for these results were again unclear. As described above, even if the result is “failed” in the AE test under reduced pressure, no problem occurs because quality of the product can be ensured to some extent.

In Example 3, in comparison with Example 1, the degree of lowering of Hn is reduced. Hn in Example 3 is on the same level as in Example 2. Even in Example 3, it is assumed that an effect of suppressing oxidization of the magnetic layer is attained in the same way as in Example 2. However, which of the patterned media is to be used from those in Example 2 and Example 3 is properly selected in accordance with system requisite specification or easiness of fabricating the media. These effects can be attained even in the case where different materials are used for the first base material and the second base material.

TABLE 3

| | | | | Mor- | | | |
|---|---|---|---|---|---|---|---|
| | | Bar- | | phology | | | AE test |
| | First | rier | Second | of | | | under |
| | base | mate- | base | barrier | Hn | AE | reduce |
| | material | rial | material | material | (kOe) | test | pressure |
| Example | Cu | Mg | Cu | Layer | 2.2 | Passed | Passed |
| Example | Cu | Al | Cu | Layer | 2.3 | Passed | Passed |
| Example | Cu | Ti | Cu | Layer | 2.1 | Passed | Passed |
| Example | Cu | V | Cu | Layer | 2 | Passed | Passed |
| Example | Cu | Zn | Cu | Layer | 2.3 | Passed | Passed |
| Example | Cu | Ga | Cu | Layer | 2.1 | Passed | Passed |
| Example | Cu | Ge | Cu | Layer | 2 | Passed | Passed |
| Example | Cu | Sr | Cu | Layer | 2.3 | Passed | Passed |
| Example | Cu | Zr | Cu | Layer | 2.1 | Passed | Passed |
| Example | Cu | Nb | Cu | Layer | 2 | Passed | Passed |
| Example | Cu | Mo | Cu | Layer | 2.3 | Passed | Passed |
| Example | Cu | In | Cu | Layer | 2.1 | Passed | Passed |
| Example | Cu | Sn | Cu | Layer | 2 | Passed | Passed |
| Example | Cu | Sb | Cu | Layer | 2.3 | Passed | Passed |
| Example | Cu | Te | Cu | Layer | 2.1 | Passed | Passed |
| Example | Cu | Ba | Cu | Layer | 2 | Passed | Passed |
| Example | Cu | Hf | Cu | Layer | 2.3 | Passed | Passed |
| Example | Cu | Ta | Cu | Layer | 2.1 | Passed | Passed |
| Example | Cu | W | Cu | Layer | 2 | Passed | Passed |
| Example | SiAlON | Mg | SiAlON | Grains | 2.3 | Passed | Failed |
| Example | SiAlON | Cu | SiAlON | Grains | 2.5 | Passed | Failed |
| Example | ZrO2 | Mg | ZrO2 | Grains | 2.2 | Passed | Failed |
| Example | ZrO2 | Al | ZrO2 | Grains | 2.2 | Passed | Failed |
| Example | Cu | Al | CuTa | Layer | 2.1 | Passed | Passed |
| Example | Cu | Al | CuTa | Layer | 2 | Passed | Passed |
| Control | — | — | — | — | 2.5 | Passed | Passed |

### Example 4

Patterned media and magnetic recording/reproducing apparatuses having a construction similar to that of Example 1 were fabricated. However, SiO₂ or C was used as a base material, and Mg, Al, or Ti was used as a barrier material. After a first base material, a barrier material, and a second base material were sequentially deposited as filling materials, the filling material was etched back by ion milling using Ar ions. At this time, whether etching of the barrier material occurred was monitored in real time using a simplified ion analysis apparatus (MALIN series manufactured by ULVAC). This ion analysis apparatus can perform ion mass analysis even under a sputtering gas pressure. Although only ions having a mass number up to 37 can be measured, the barrier material used in this Example can be analyzed, thus enabling detection in real time. In practice, a correlation between an etching amount and a detection amount by mass analysis was obtained in advance, and etching was controlled utilizing that correlation. Table 4 shows materials for the first base material, barrier material, and second base material. Table 4 also shows results obtained by carrying out evaluations similar to those in Example 1. As a result of TEM observation, all of the barrier materials were formed in a layer. This is because the barrier layer was deposited slightly thick so that an optimal etching amount can be detected by mass analysis. Unlike Examples 1 to 3, Hn increased in the patterned media in this Example. This is considered to be because a combination of the base materials and barrier material selected in this Example was optimal, and oxidization of the magnetic film was suppressed almost completely. Also, in the case where the magnetic film was patterned ideally, the patterned shape is close to a rectangular, leading to reduced demagnetizing field. It seems that Hn was increased because of these reasons. In addition, all of the apparatuses were passed in the AE test under reduced pressure as well as the AE test under normal pressure. It seems that these results were obtained because the effect by the barrier material of suppressing elution of element was improved. There is a possibility that a small degree of oxidization brings about improvement of head-disk interface (HDI) characteristics. These effects can be obtained even in the case where different materials are used for the first base material and the second base material. As in this Example, it was found that the best characteristics as a hard disk drive can be attained in media using SiO₂ or C as the first and second base materials in combination with Mg, Al, or Ti as a barrier material.

TABLE 4

| | | | | Mor- | | | |
|---|---|---|---|---|---|---|---|
| | | Bar- | | phology | | | AE test |
| | First | rier | Second | of | | | under |
| | base | mate- | base | barrier | Hn | AE | reduce |
| | material | rial | material | material | (kOe) | test | pressure |
| Example | C | Mg | C | Layer | 2.9 | Passed | Passed |
| Example | C | Al | C | Layer | 2.8 | Passed | Passed |
| Example | C | Ti | C | Layer | 3 | Passed | Passed |
| Example | SiO2 | Mg | C | Layer | 3 | Passed | Passed |
| Example | SiO2 | Al | C | Layer | 2.8 | Passed | Passed |
| Example | SiO2 | Ti | C | Layer | 3 | Passed | Passed |
| Example | C | Mg | SiO2 | Layer | 2.7 | Passed | Passed |
| Example | C | Al | SiO2 | Layer | 2.8 | Passed | Passed |
| Example | C | Ti | SiO2 | Layer | 2.7 | Passed | Passed |
| Example | SiO2 | Mg | SiO2 | Layer | 2.9 | Passed | Passed |
| Example | SiO2 | Al | SiO2 | Layer | 2.8 | Passed | Passed |
| Example | SiO2 | Ti | SiO2 | Layer | 2.7 | Passed | Passed |
| Example | SiO2 | Mg | SiO2 | Layer | 2.8 | Passed | Passed |
| Example | SiO2 | Al | SiO2 | Layer | 2.7 | Passed | Passed |
| Example | SiO2 | Ti | SiO2 | Layer | 2.7 | Passed | Passed |
| Control | — | — | — | — | 2.5 | Passed | Passed |

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A patterned media comprising:
a magnetic film processed into patterns for tracks, servo zones or data zones; and
a nonmagnetic filling material filled between patterns of the magnetic film for the tracks, servo zones or data zones and including a base material and a barrier material formed of a metal that does not constitute the base material.

2. The patterned media according to claim 1, wherein the base material is formed of C or a compound of Si, Ta or Ti with O or N.

3. The patterned media according to claim 1, wherein the barrier material is formed of at least one metal selected from the group consisting of Mg, Al, Ti, V, Cu, Zn, Ga, Ge, Sr, Zr, Nb, Mo, In, Sn, Sb, Te, Ba, Hf, Ta and W.

4. The patterned media according to claim 1, wherein the barrier material is formed in a layer.

5. The patterned media according to claim 1, wherein the filling material has a structure in which a first base material, a barrier material and a second base material are stacked.

6. A method of manufacturing a patterned media, comprising:
processing a magnetic film into patterns for tracks, servo zones or data zones;
depositing a barrier material and a base material to form a nonmagnetic filling material between and on the patterns of the magnetic film for the tracks, servo zones or data zones; and
etching the base material and the barrier material on the patterns of the magnetic film, the barrier material being higher in an etching rate than the base material.

7. The method according to claim 6, wherein a first base material, a barrier material and a second base material are deposited.

8. A magnetic recording/reproducing apparatus, comprising:
the patterned media according to claim 1; and
a read-write head incorporated in a slider having a designed flying height of 15 nm or less.
